(19) United States
(12) Patent Application Publication
(10) Pub. No.: US 2025/0248350 A1
(43) Pub. Date: Aug. 7, 2025

(54) COLUMN SEGMENT FOR GROWING PLANTS

(71) Applicant: Invertigro Pty Ltd, Rosebery, New South Wales (AU)

(72) Inventors: Benestine Lee, Rushcutters Bay, New South Wales (AU); Todd EBERLINE, Erskineville, New South Wales (AU); Paul MILLETT, Elanora Heights, New South Wales (AU); Neill WAINWRIGHT, Willoughby, New South Wales (AU)

(21) Appl. No.: 18/856,598

(22) PCT Filed: Apr. 12, 2023
(86) PCT No.: PCT/AU2023/050302

§ 371 Date: Oct. 12, 2024

(30) Foreign Application Priority Data
Apr. 13, 2022 (AU) 2022900983

(51) Int. Cl. A01G 31/02

(52) U.S. Cl. CPC A01G 31/025

(57) ABSTRACT

The following disclosure relates to column segments for the growing of plants or crops. These column segments comprise a plurality of wall panels, at least one opening in the wall panels in which at least one pot for holding plants can be located; a diffuser which is configured to locate the wall panels in a pre-determined position that forms an internal cavity, and to distribute liquid into the internal cavity such that a greater amount of fluid is directed proximate the at least one opening in the wall panels relative to the rest of the cavity; and a locking ring which secures the wall panels and diffuser together in the predetermined position.

### TECHNICAL FIELD

The present disclosure relates to a column segment for growing plants and a column comprising multiple column segments as used, for example, in hydroponic systems.

### BACKGROUND OF THE DISCLOSURE

Constant attempts have been made to improve the efficiency of growing plants/crops for agricultural purposes such as providing ingredients for foods, textiles or medicines. As part of these efforts, a number of modern growing techniques have been developed, such as hydroponics, aeroponics, and nutrient film technique (NFT) which are aimed at reducing the amount of soil and/or land required to grow said plants/crops compared to conventional agricultural techniques. These techniques have resulted in the development of vertical indoor farming, where plants/crops are grown indoors in vertically stacked arrangements which further increase the number of plants/crops which can be grown in a set area compared to conventional farming and allows for the industrial scale growing of crops closer to urban areas.

Some vertical indoor farming systems use a series of columns or vertical tubes in which plants can be grown. Such columns are often little more than hollow cylinders with openings along their length in which pots or containers for plants can be placed so that the roots of the plants grow into the hollow interior of the cylinder. Water can then be gravity fed from the top of the column through the interior so that the roots and grow medium can be wetted. In some cases, the water is fed into the top of the column in cycles to alternate between soaking the grow media and allowing oxygen to pass into the roots.

A problem with current growing columns is that they are typically formed as either whole columns or column segments. As a large scale farm may require, for example, between 8000 to 10,000 columns at a minimum in order to produce a commercially viable yield, transporting these columns or column segments requires a large amount of freight volume. Further, the size of these columns makes their installation difficult by a single user. Additionally, these columns are hard to clean, which is important in maintaining the hygiene of the system and health of the crops being grown. It may also be hard to adequately distribute water to all plants across the length of the columns for relatively tall columns. More specifically, the height of current growing columns is limited as the amount of water loss increases over longer columns, meaning that some plants will not receive the required water to grow or survive.

Preferred embodiments of the present invention seek to provide a column segment for growing plants or crops and a column comprised of said segments which at least partially addresses these problems.

### SUMMARY OF THE INVENTION

According to a first aspect, there is provided a column segment for growing plants or crops, comprising: a plurality of wall panels, at least one opening in the wall panels in which at least one pot for holding plants can be located; a diffuser which is configured to locate the wall panels in a predetermined position that forms an internal cavity, and to distribute liquid into the internal cavity such that a greater amount of fluid is directed proximate the at least one opening in the wall panels relative to the rest of the cavity; and a locking ring which secures the wall panels and diffuser together in the predetermined position.

In certain embodiments, a seal exists between the plurality of wall panels when assembled together.

In certain embodiments, each wall panel includes a first sealing member on a side and a second sealing member extending from an opposing side such that when two panels are located in the predetermined position, and the seal is formed by the first and second sealing members co-operating to prevent liquid from passing between the two panels.

In certain embodiments, the diffuser is further configured to also locate the wall panels of a second column segment in addition to the wall panels of a first column segment.

In certain embodiments, the diffuser is configured to locate the wall panels of the first column segment below the diffuser and the wall panels of the second column segment above the diffuser.

In certain embodiments, the first sealing member is an integrated rubber lip seal and the second sealing member is a flange which extends from the opposing side.

In certain embodiments, the locking ring secures the wall panels and diffuser together in a fixed position by providing a compressive force against the diffuser and wall panels.

In certain embodiments, the locking ring secures the wall panels and diffuser together in a fixed position by means of co-operating grooves or ridges on the diffuser or wall panels and the locking ring.

In certain embodiments, the diffuser includes a lip seal which is sealed by the compressive force provided by the locking ring.

In certain embodiments, the diffuser distributes liquid by means of a convex plate with a first set of openings and a second set of openings, wherein the second set of openings are shaped to allow a greater volume of liquid to pass through the diffuser relative to the first set of openings.

In certain embodiments, the wall panels include protrusions which extend at an angle to a main plane of the wall panels, and the opening(s) are located on a surface of the protrusions.

In certain embodiments, the plurality of wall panels are shaped such that they can be stacked when not assembled.

In certain embodiments, the wall panels are curved and form a cylindrical internal cavity in the predetermined position.

In certain embodiments, there are four wall panels.

In certain embodiments, each wall panel includes two openings.

According to a second aspect, there is provided a column for growing plants or crops, comprising multiple column segments according to the first aspect.

According to a third aspect, there is provided a hydroponic system for growing plants or crops, including either a column according to the second aspect or at least one column segment according to the first aspect.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE FIGURES

The present disclosure will become better understood from the following detailed description of various non-limiting embodiments thereof, described in connection with the accompanying figures, wherein:

FIG. 1 shows an embodiment of a growing column according to the present invention.

FIG. 2 shows a close up of two column segments according to the present invention.

FIG. 3 shows two column segments according to an embodiment of the present invention with two wall panels removed to show the interior of the column.

FIG. 4 shows two column segments according to an embodiment of the present invention with two wall panels and the locking ring removed to show the diffuser and interior of the column.

FIG. 5 shows the same embodiment as FIG. 4 from below the diffuser.

FIG. 6 shows an embodiment of a wall panel for use in a column segment according to the present invention.

FIG. 7 shows an embodiment of two wall panels for use in a column segment according to the present invention.

FIG. 8 shows an embodiment of a diffuser for use in a column segment according to the present invention.

FIG. 9 shows an embodiment of a locking ring for use in a column segment according to the present invention.

FIG. 10 shows an alternative embodiment of a wall panel for use in a column segment according to the present invention.

FIG. 11 shows an alternative embodiment of a column segment according to the present invention.

### DETAILED DESCRIPTION

To address the known issues with existing growing columns, the inventors have created a growing column which can be disassembled not only into segments but further into a set of wall panels, diffuser and locking ring which can be stacked or ‘flat-packed’ for storage and transportation without taking up a large volume of space.

The present invention provides a column segment for growing plants or crops, and columns comprised of these segments. Each segment includes a plurality of wall panels, the wall panels including openings for plants or crops. In some embodiments, these wall panels are identical to each other, which allows easier manufacture and results in a simpler assembly process for a user. It will be understood that the number and nature of the openings may differ depending on the type of plant or crop being grown, or the nature of the growing system. Typically, however, said openings will enable a plant in a container containing grow medium (such as a pot) to be placed in the opening such that the bottom of the pot faces towards the interior lengthways axis of the column, and any root growth from the pot occurs into the interior of the column. It will be further understood that in some embodiments, some wall panels may contain openings while others do not, for instance where the plant being grown requires a relatively large amount of space. In these embodiments, the wall panels without openings are preferably designed to still be stackable in a manner that allows transportation and storage in a small volume of space compared to other plant columns.

Each wall panel includes elements which are designed to guide a user to locate the panels together. In preferred embodiments, this may take the form of a rubber lip seal on one side edge of each panel and a flange or protruding sealing wall extending from an opposing side edge. Thus, when two panels are brought together, the sealing wall extending from the opposing side edge is pushed into the rubber lip seal on the first side edge to provide a sealing fit, and one side edge of the combined panels includes the rubber lip seal of the first wall panel and the opposing side edge of the combined panels includes the sealing wall of the second wall panel. Further wall panels can be located in these features to form a complete column wall. In these preferred embodiments, the rubber lip seal and the sealing wall act not only to locate the wall panels but ensure that there is a watertight connection which hinders or prevents liquid from passing out of the column between the wall panels. Additionally, the flange or sealing wall may extend at an angle to ensure adjacent wall panels are located at the correct position.

Preferably, the wall panels are curved, and together form a cylindrically shaped segment, though it will be understood that in other embodiments, other shapes may be used, such as flat panels, or panels consisting of two flat surfaces angled relative to each other. In these other embodiments, the resultant column segment may be shaped as a rectangular, hexagonal or other polygonal prism instead without departing from the spirit of the invention. These wall panels, whether flat, curved, or consisting of multiple angled flat surfaces, can be stacked or ‘flat-packed’ on top of one another as each wall panel in the embodiment will have the same angles/curved surfaces.

It will be understood by a person skilled in the art that in other embodiments, other known suitable materials for lip seals, such as elastomeric or thermoplastic materials, may be used in place of rubber. In further embodiments, other known methods of creating a waterproof seal between two panels may be used, provided that they do not prevent the wall panels from being disassembled and reassembled.

Between each set of wall panels is a diffuser. In preferred embodiments, the diffuser is shaped as a convex disc and peripheral ring, where the disc lies approximately perpendicular to the lengthwise direction of the column and the peripheral ring aligns with the cross-section of the wall panels. The diffuser serves two functions. Firstly, it is configured to locate the wall panels in a predetermined position. In preferred embodiments, this may be achieved by co-operating grooves and protrusions on the diffuser and wall panels respectively, or vice-versa. Secondly, the diffuser collects and redirects liquid (typically water or nutrient solutions) back towards plants in a segment below. Owing to the presence of the diffuser between segments, the columns can be made taller than existing columns as less liquid will be lost or directed against the side walls or through the middle of the column compared to existing columns.

In preferred embodiments, the diffuser directs liquid via an array of small openings or holes distributed across the surface of the convex disc through which water can pass from above the diffuser below into the interior cavity of the column segment where it can moisten the roots and growing media of the plants being grown in the segment. As the growing media and roots will be concentrated around the periphery of the hollow interior (because the plants are growing in pots located in openings of the wall panels), the watering efficiency can be achieved through providing a greater concentration of water to the periphery relative to the middle of the interior of the column segment. Accordingly, larger, directional openings may also be present proximate the periphery of the convex disc and above an opening or openings for plant pots to direct water towards them. In particularly preferred embodiments, the diffuser is designed to only locate the wall panels in a set position where at least one larger opening is positioned substantially vertically in line with the plant pot openings of the wall panels. Preferably, the diffuser also includes a seal, such as a lip seal which hinders or prevents the flow of water between the diffuser and wall panels. As wall panels may be provided above and below the diffuser, multiple seals may be provided on either or both sides of the diffuser.

To secure the wall panels and diffuser together, a locking ring is also provided which, in preferred embodiments, fits over the diffuser and is shaped as a ring slightly larger than the peripheral ring of the diffuser. The diffuser and locking ring may have co-operating ridges or grooves which enable the locking ring to be positioned in one position where it can be slid on and off the column and twisted to provide a compressive force to the diffuser and wall panels such that they are secured in position. When a user wants to disassemble the column segment, they are able to twist the locking ring in an opposite direction in order to release the diffuser and wall panels. In this way, a column according to the present invention may be quickly and easily assembled and disassembled by twisting the locking rings to secure/release the wall panels and diffuser together. This allows the quick and easy disassembly for cleaning the column segments, for example by placing the disassembled components in a typical dishwasher.

This improved column segment provides a number of advantages over existing columns for growing plants, including reducing transportation and storage costs, and reducing the carbon footprint of establishing and maintaining a large scale vertical farming system (through reduced transportation needs). While plant columns according to the present invention are able to be disassembled into these ‘flat-packable’ elements, the resultant column is still able maintain a water-tight and structurally rigid column for plants or crops to grow in.

Additionally, the column segments can be assembled by hand, without the need for tools, on site. The modular nature of the column segments also enable columns of any height to be created (as column segments may essentially be added infinitely), with the diffuser ensuring that liquid is distributed to plants along the entire column even when the assembled column is of a large height. The process of assembling such a column is relatively simple. A user simply connects together the wall panels, which preferably have a connection means which ensures they can only be inserted in the correct position, before placing a diffuser and locking ring on top. The diffuser includes a locating means, such as a ridge with recesses to match tabs on the wall panels to ensure that the diffuser can only be placed on the wall panels in the correct position. A second set of wall panels is then assembled in the same manner of the first and placed on top of the diffuser, which preferably has the same or similar means to ensure the second set of wall panels can only be located on the diffuser in the correct position. The user then simply engages the locking ring (for example, by twisting or turning the locking ring) to secure the panels and diffuser together.

Further, due to the modularity of the column, a user is able to scale up or down the size of the farming system with greater ease and flexibility relative to existing column systems. Another advantage over conventional systems, owing to the ability to disassemble the column segments into the wall panels, diffuser, and locking ring, is the components of the growing column are capable of being cleaned in a standard commercial dishwasher.

Throughout this specification, the term ‘water’ in the context of supplying water to the plants/crops being grown is intended to encompass nutrient-rich solutions used in conjunction with known agricultural techniques for growing plants as well.

The present disclosure will become better understood from the following example of a non-limiting embodiment.

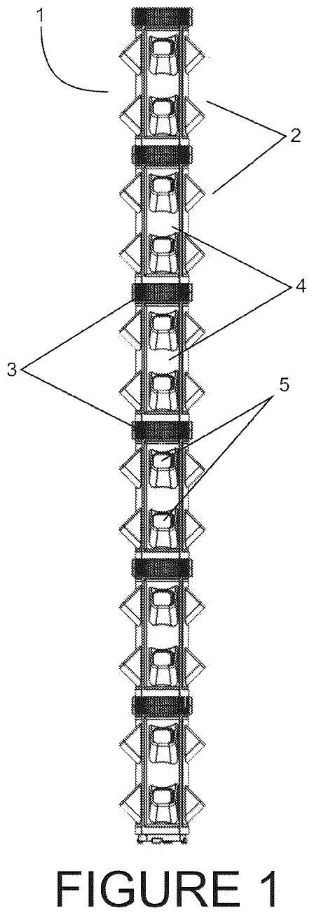

FIG. 1 shows an embodiment of a growing column according to the present invention. The column 1 is comprised of column segments 2. Each column segment 2 is comprised of wall panels 4, diffuser (not shown) and locking ring 3. In this embodiment, each wall panel 4 includes two openings 5 in which plants can be grown. In this embodiment, the openings are located on inclined protrusions so as to angle the pot and plant being grown upwards, to aid in ensuring the plant gets sufficient light to grow. In some embodiments, the protrusions are shaped so as to still allow flat packing or stacking of the wall panels when in storage or transport. For example, the protrusions may be shaped in such a way that the panels can be tessellated or otherwise arranged to minimise the volume of the stored column, or the protrusions shaped in a way that the protrusion of a first wall panel fits into cavity formed by the protrusion of a second wall panel when the second is stacked directly on the first wall panel so that the outer surface of the first wall panel contacts the inner surface of the second wall panel. The openings themselves are shaped as rounded squares so as to accept correspondingly shaped pots, the pots each including growing medium and at least one plant for growing. It will be understood that in other embodiments, differently shaped openings may be present instead for differently shaped pots, and/or there may be more or fewer openings present in each panel.

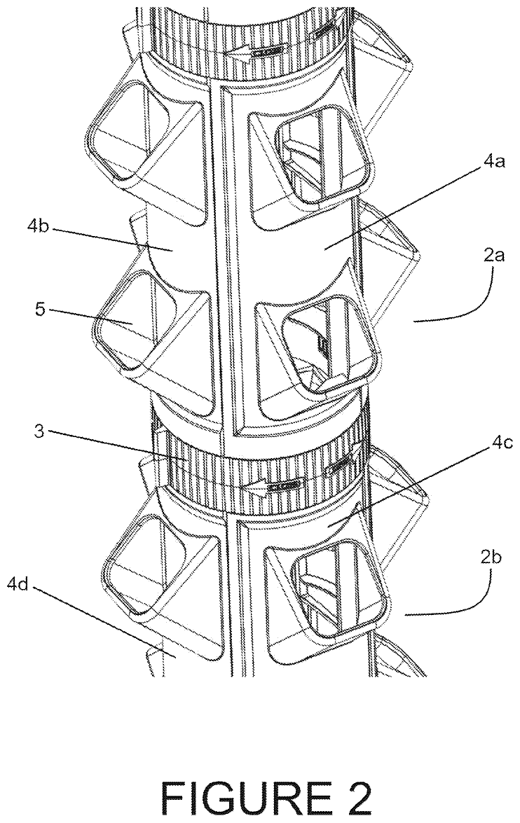

FIG. 2 shows a close up of an embodiment of a column according to the present invention. In this image, it can more easily be seen that the column is made up of segments (2a, 2b shown in this image), and that each segment is made up of multiple wall panels 4a, 4b shown for segment 2a and wall panels 4c and 4d. In this embodiment, each segment is made out of four wall panels, each of which is curved such that, when put together, they form an approximately cylindrical interior space. The locking ring 3 is also shown, in a closed position which secures the wall panels and diffuser (not shown) together.

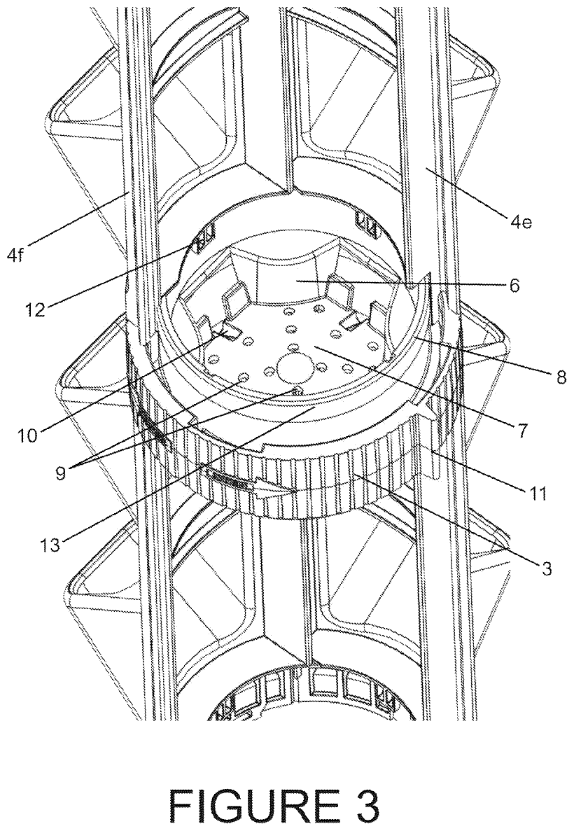

FIG. 3 shows a view of the same embodiment as FIG. 2 where wall panels 4a, 4b, 4c, and 4d have been removed. In this figure, it is possible to see the interior cavity of a column segment according to the present invention and diffuser 6 which is situated between adjacent column segments. The diffuser 6 in this embodiment is in the form of a plate or disc 7 which is surrounded by a peripheral ring 8. The disc 7 is convex, that is to say, the centre of the plate is raised higher than the periphery, and includes an array of small openings 9 over its surface. Around the periphery of the disc 7 are larger openings 10 which in this embodiment are in the form of waterspouts which align with the openings in the wall panels below the diffuser. The peripheral ring 8 has a diameter similar to that of the combined wall panels such that the diffuser is able to locate the wall panels. In this embodiment, this is achieved through tabs on the top and bottom edges of each wall panel which match with recesses in a ridge located on an exterior surface of the peripheral ring 8 of the diffuser (not shown) as well as protrusions 12 on a bottom wall of the wall panels which, when placed in the correct position, extend over the interior side of the peripheral ring 8. As a result, the wall panels are capable of holding their own weight and staying in position prior to being secured by the locking ring. More specifically, in this embodiment, each wall panel has a cut out portion at its base which is shaped to match the peripheral ring 8 of the diffuser. A base wall extends from the top of this cut out portion which includes protrusions which fit either side of the peripheral ring to locate the panel at a set position. The peripheral ring 8 of the diffuser 6 also includes an integrated rubber lip seal 13 which, when pressed against the wall panels by the diffuser ring, prevents water from tracking under the wall panel and leaking out of the column.

FIG. 3 also shows the locking ring 3 in place, though in typical assembly the locking ring would not be in place without all the wall panels being in place. In this embodiment, it can be seen that the locking ring 3 has a number of features to make it easier for a user to turn it, including directional arrows and ridges on an outer surface of the ring, as well as larger intermittent ridges 11 which make it easier for a user to apply a twisting force to the ring.

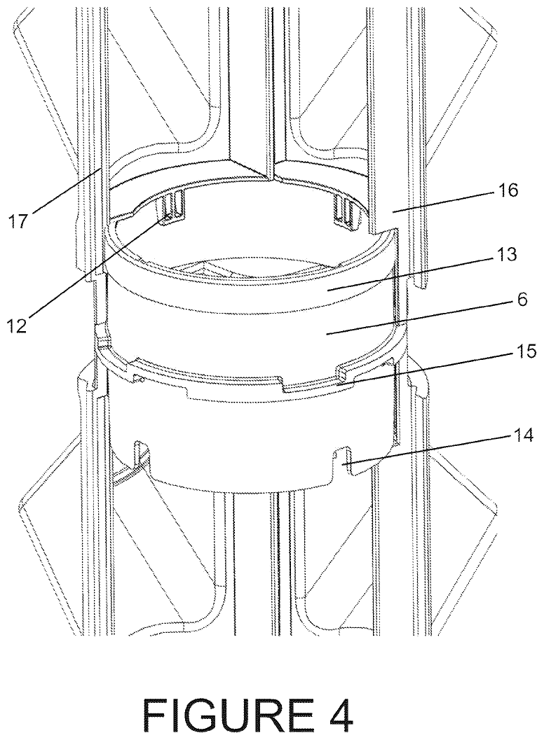

FIG. 4 shows the embodiment of FIG. 3 with the locking ring removed. In this figure, it is possible to see that the diffuser 6 in this embodiment includes cut out portions 14 which align with the larger openings to ensure that water is directed towards the openings of the wall panels below. It is also possible in this figure to see that the diffuser 6 has a locator ridge 15 around an outer edge of the peripheral ring. This co-operates with corresponding tabs on the top and bottom edges of the wall panels to ensure that the panels are positioned in the desired position. The ridge 15 and tabs may also co-operate with a ridge on the locking ring to allow the locking ring to be placed over the diffuser in one position and then twisted to another position where the ring applies a compressive force to the diffuser and wall panels and cannot be removed without first twisting it in an opposite direction.

In this view, the integrated rubber lip seal 17 and corresponding sealing wall 16 of two wall panels can also be seen. These correspond to each other so that the sealing wall of one panel is located to seal against the rubber lip seal of an adjacent panel when placed together.

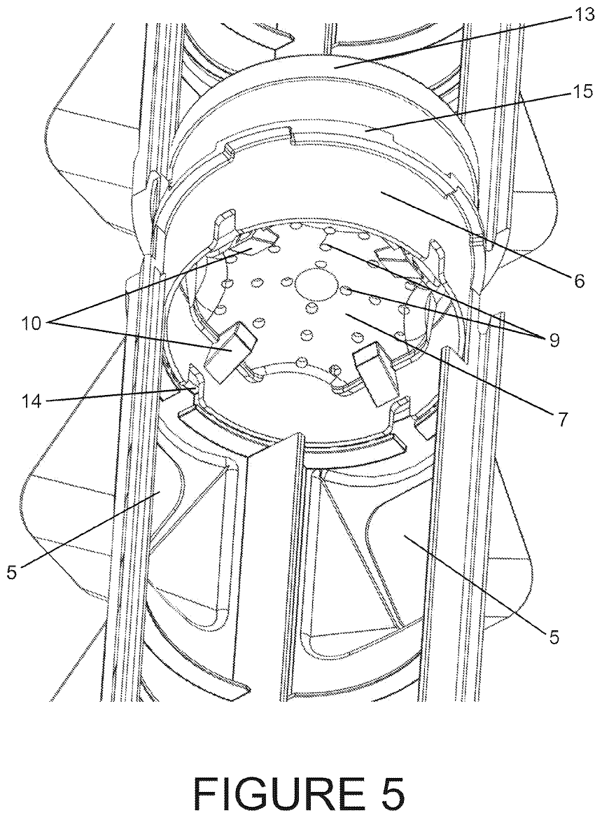

FIG. 5 shows the embodiment of FIG. 4 from below. From this angle, the underside of the diffuser 6 can be seen, including the convex disc 7 (which from beneath appears concave) and array of openings 9. From this angle, it is possible to see that the larger openings 10, also referred to as waterspouts include channels which extend at an angle out from below the disc 7 towards the openings of wall panels below the diffuser 6. Water which enters the top of the diffuser will flow through these waterspouts and past the cut out sections 14 of the diffuser to provide water to the plants growing in the openings 5 of the growing column. To ensure water is still provided to root growth into the centre of the interior of the growing column and to prevent any blockages within the column, the smaller array of openings 9 allows some water to be distributed across the interior cavity of the column segment. The rubber lip seal 13 and locator ridge 15 of the diffuser 6 can also be seen in this figure.

The resultant distribution pattern of water concentrates a larger amount of water proximate the openings, in a way that, when a pot is inserted into the opening, ensures that the pot and growing medium within is soaked as required to ensure the plants successfully grow.

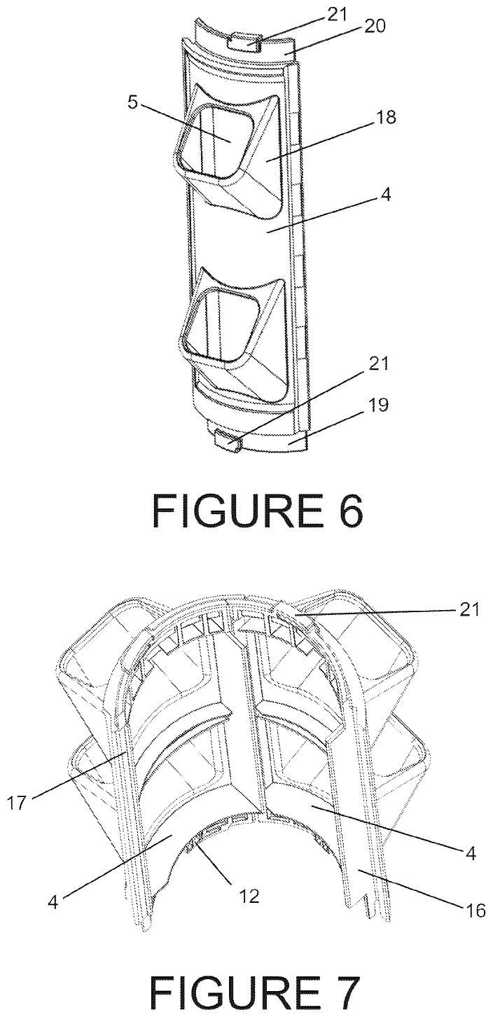

FIG. 6 shows an embodiment of a single wall panel according to the invention. In this embodiment, the wall panel 4 is curved so as to form a cylindrical shape when combined with other wall panels. In this embodiment, protrusions extend angularly from an outer surface of the wall panel 4, each protrusion 18 including an opening 5 in which pots for plants can be placed such that the growing medium and root system of the plant is locatable in the interior cavity formed by multiple wall panels. It will be understood that other numbers and shapes of openings may be present on the wall panel, preferably tailored towards certain crops or plants, without departing from the scope of the invention. Each wall panel has a base edge 19 and a top edge 20 which are recessed relative to the main plane of the wall panel. These are shaped to correspond to the diameter of the diffuser. Both the base edge 19 and top edge 20 include locating tabs 21 which co-operate with elements of the diffuser to locate each section in a desired place. In this embodiment, these elements are in the form of a locator ridge located on a periphery of the diffuser. The top locating tab is offset from the bottom locating tab to allow identical wall panels to be located directly above each other when located by the ridge in the diffuser.

FIG. 7 shows two wall panels 4 according to the present invention which have been connected together. In practice, four of this embodiment of the wall panels would be connected to form an interior cavity which is substantially cylindrical in shape. Accordingly, the two wall panels together define a curve in cross section which is approximately semi-circular in shape. It will be understood that in other embodiments, the wall panels may be shaped differently and thus fewer or more wall panels may be required to form the interior cavity. Each wall panel includes a means of providing a seal between two adjacent members, in this embodiment, the seal is provided by a rubber lip seal on one side edge of the wall panel and a sealing wall which extends from an opposing side edge. Accordingly, when these two elements are pressed together, a seal is formed to prevent water leaking out of the column. The resultant combination of two panels also includes a rubber lip seal on one side edge and a sealing wall extending from an opposing side edge. This will also be true of three wall panels connected together, allowing a fourth to then be connected. Locator tabs 21 at the top of these connected wall panels allow said panels to be located by the diffuser. Also viewable from this angle is protrusion 12, which when placed on the diffuser, is located on the opposite side to the locator tabs to allow the wall panel to support its own weight when being assembled.

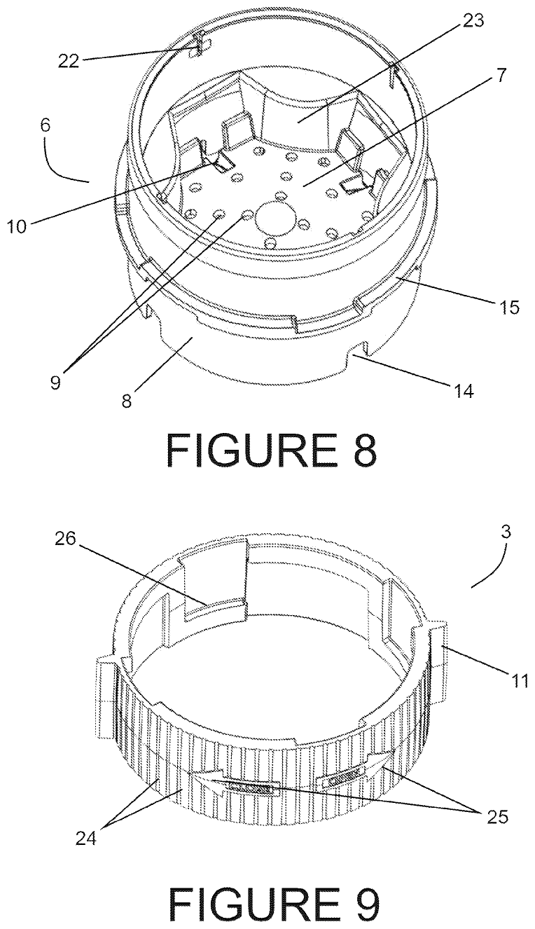

FIG. 8 shows an embodiment of a diffuser according to the present invention. The diffuser 6 includes a convex ring 7 including an array of smaller openings 9 as well as larger openings 10 around the periphery of the disc, and a peripheral ring 8 which includes a locator ridge 15 around an external surface to locate the tabs of the wall panels. The peripheral ring also includes openings 14 at a lower surface to allow water to pass directly towards the plants being grown. In this view, secondary locator grooves 22 can be seen at the top internal edge of the peripheral ring, these co-operate with protrusions in the wall panels above to ensure the wall panels can support its own weight when being assembled. Channelling walls 23 may also be provided extending from internal surfaces of the peripheral ring over the convex disc to further channel water towards the larger openings.

FIG. 9 shows an embodiment of a locking ring according to the present invention. The ring includes small ridges on an exterior surface in order to increase friction for a user when turning as well as two large ridges 11 which make it easier for a user to apply directional force when turning. The ring also includes embossed arrows which show the direction to turn when locking/unlocking the locking ring. On an interior surface, the locking ring includes a ridged pattern which enables the ring to be placed over the diffuser and wall panels in a first position and then, when turned to a second position, pushes against the wall panels and/or diffuser to hold said elements in place.

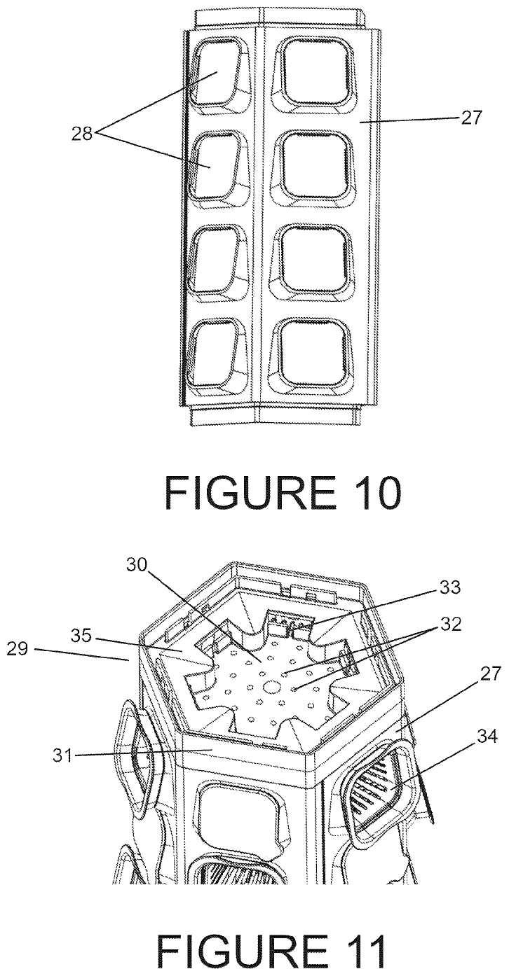

FIG. 10 shows a wall panel according to another embodiment of the invention. In this embodiment, the wall panel 27 is not curved but rather is formed from two flat surfaces obtusely angled to each other. In this embodiment, there are eight openings 28 for growing plants in each panel, four on each flat surface. This embodiment also features the similar connecting means as previously discussed embodiments, such that when multiple panels are connected together (in this embodiment, three identical panels), an interior cavity is produced. In this embodiment, the cavity is shaped as a hexagonal prism.

FIG. 11 shows a view of a column segment composed of the same wall panels 27 as shown in FIG. 10, along with a diffuser 29 which in this embodiment is in the form of a hexagonal surface 30 and peripheral hexagonally shaped ring 31. In the same manner as previous embodiments, the diffuser includes an array of smaller openings 32 across the hexagonal surface 30 and larger openings 33 located around the periphery of the surface. These larger openings 33 align with plant pots 34 in openings of the wall panels 27 so that any plants within said pots can receive water. As with other embodiments, the diffuser also includes channelling walls 35 which direct water towards the larger openings 33 on the hexagonal surface 30.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A column segment for growing plants or crops, comprising:
a plurality of wall panels,
at least one opening in the wall panels in which at least one pot for holding plants can be located;
a diffuser which is configured to locate the wall panels in a predetermined position that forms an internal cavity, and to distribute liquid into the internal cavity such that a greater amount of fluid is directed proximate the at least one opening in the wall panels relative to the rest of the cavity; and
a locking ring which secures the wall panels and diffuser together in the predetermined position.

2. The column segment according to claim 1, wherein a seal exists between the plurality of wall panels when assembled together.

3. The column segment according to claim 2, wherein each wall panel includes a first sealing member on a side and a second sealing member extending from an opposing side such that when two panels are located in the predetermined position, and the seal is formed by the first and second sealing members co-operating to prevent liquid from passing between the two panels.

4. The column segment according to claim 1, wherein the diffuser is further configured to also locate the wall panels of a second column segment in addition to the wall panels of a first column segment.

5. The column segment of claim 4, wherein the diffuser is configured to locate the wall panels of the first column segment below the diffuser and the wall panels of the second column segment above the diffuser.

6. The column segment of claim 1, wherein the first sealing member is an integrated rubber lip seal and the second sealing member is a flange which extends from the opposing side.

7. The column segment according to claim 1, wherein the locking ring secures the wall panels and diffuser together in a fixed position by providing a compressive force against the diffuser and wall panels.

8. The column segment according to claim 1, wherein the locking ring secures the wall panels and diffuser together in a fixed position by means of co-operating grooves or ridges on the diffuser or wall panels and the locking ring.

9. The column segment according to claim 7, wherein the diffuser includes a lip seal which is sealed by the compressive force provided by the locking ring.

10. The column segment according to claim 1, wherein the diffuser distributes liquid by means of a convex plate with a first set of openings and a second set of openings, wherein the second set of openings are shaped to allow a greater volume of liquid to pass through the diffuser relative to the first set of openings.

11. The column segment according to claim 1, wherein the wall panels include protrusions which extend at an angle to a main plane of the wall panels, and the opening(s) are located on a surface of the protrusions.

12. The column segment according to claim 1, wherein each wall panel is identical.

13. The column segment of claim 1, wherein the plurality of wall panels are shaped such that they can be stacked when not assembled.

14. The column segment of claim 1, wherein the wall panels are curved and form a cylindrical internal cavity in the predetermined position.

15. The column segment of claim 14, wherein there are four wall panels.

16. The column of claim 15, wherein each wall panel includes two openings.

17. A column for growing plants or crops, comprising multiple column segments according to claim 1.

18. A hydroponic system for growing plants or crops, including a column according to claim 17.

19. A hydroponic system for growing plants or crops, including at least one column segment according to claim 1.
